(19) United States
(12) Patent Application Publication
(10) Pub. No.: US 2013/0269289 A1
(43) Pub. Date: Oct. 17, 2013

(54) SYSTEM, METHOD AND APPARATUS FOR FIBER CEMENT UNDERLAYMENT OR BACKERBOARD

(71) Applicants: Thomas C. Gilbert, Clarklake, MI (US); Robert E. Battles, Marshall, IL (US); David H. Steele, Jackson, MI (US)

(72) Inventors: Thomas C. Gilbert, Clarklake, MI (US); Robert E. Battles, Marshall, IL (US); David H. Steele, Jackson, MI (US)

(21) Appl. No.: 13/857,703

(22) Filed: Apr. 5, 2013

Related U.S. Application Data
(60) Provisional application No. 61/622,903, filed on Apr. 11, 2012.

(51) Int. Cl. E04C 2/30; B23K 26/40; B26D 3/00; B23B 35/00; E04C 2/06; B29C 59/02

(52) U.S. Cl. CPC E04C 2/30; E04C 2/06; B29C 59/02; B26D 3/00; B23B 35/00; B23K 26/40
USPC 52/782.1; 52/745.21; 264/293; 428/156; 83/861; 408/1 R; 264/400

(57) ABSTRACT

A building sheet includes a substantially flat board having a front surface, a back surface and a thickness defined therebetween. At least one of the front and back surfaces defines a surface direction. The thickness defines a thickness direction that is substantially perpendicular to the surface direction. Recesses are formed in at least one of the front and back surfaces. The recesses have a maximum dimension in the surface direction of less than 3/8 inch, such that each recess is too small to receive a head of the fastener.

This application claims priority to and the benefit of U.S. Provisional Pat. App. No. 61/622,903, filed Apr. 11, 2012, and is incorporated herein by reference in its entirety.

### BACKGROUND OF THE INVENTION

1. Field of the Disclosure

The present invention relates in general to building sheets and, in particular, to a system, method and apparatus for a fiber cement underlayment or backerboard.

2. Description of the Related Art

Building sheets made of fiber cement and other materials are often used as backerboards for floors, countertops, walls, etc. For example, backerboards for ceramic tiles are used for countertops to provide the water resistant, relatively rigid, dimensionally-stable foundation over which the tile is bonded during the installation. Conventionally, the backerboard is laid over an exterior grade sheet of plywood and adhered thereto using an adhesive such as a dry-set portland cement mortar or latex-modified portland cement mortar thinset. The backerboard is also fastened to the plywood subfloor using nails or screws. Once the backerboard is in place, ceramic tile is laid over the backerboard and adhered thereto using a modified thinset or other suitable tile adhesives. Backerboards are installed in a similar manner for a number of other applications, such as tile backer for floor installations and wallboard installations where the material is installed direct to stud or exterior sheathing or paneling applications.

For these and other applications, building sheets must generally be sized and cut to an appropriate dimension for installation. For example, tile backerboards must be appropriately sized and cut before placement over plywood subfloor. This can be a time consuming and labor-intensive process, requiring a number of different tools and great precision to size and cut a board to the desired dimension. Cutting of a backerboard typically requires using a straight edge and scoring knife to score the backerboard on one side, and then snapping the backerboard up against the edge of the straight edge to break the board along the score mark. It is often difficult, particularly for long cuts, to hold the straight edge in a fixed relationship to the material with one hand, and perform the scoring or cutting with the other hand. Resultant slippage can reduce the accuracy of the resulting cut. Alternatively, a circular saw with a carbide tipped blade or shears have also been used to cut backerboards.

To assist in determining a desired cut location, backerboards have been known to contain marker locations, for example markers six inches apart marked in ink, to indicate fastening locations for nails or drills. These markers can also provide a visual aid to enable a cutter to more easily locate a desired cutting location. U.S. Pat. No. 5,673,489 to Robell describes a gridded measurement system for construction materials such as wallboards wherein a plurality of horizontal and vertical unit measurement markings are positioned around the perimeter of the construction material surface to provide quick dimensional reference for sizing of the construction material. The construction material surface is filled with horizontal and vertical grid markings between the numbered unit measurement markings.

Construction boards with markings as described above, though generally assisting in visualizing cut locations, still do not significantly decrease the time and labor for installation. This is due in part to the fact that boards with markings still require the use of a straight edge or other tool to guide a cut mark across the board. Other designs use grooves and large nail head recesses.

Thus, there is a need for an affordable cutting and/or scoring reference for installers of backerboards and underlayment fiber cement boards. There is also a need to reduce the weight of these products and allow nails or screw fasteners to be driven flush with the surface of the sheet during installation. Improvements in building sheets continue to be of interest.

### SUMMARY

Embodiments of a system, method and apparatus for a building sheet are disclosed. For example, a building sheet may comprise a substantially flat board having a front surface, a back surface and a thickness defined therebetween. At least one of the front and back surfaces defines a surface direction. The thickness defines a thickness direction that is substantially perpendicular to the surface direction. Recesses are formed in said at least one of the front and back surfaces. The recesses have a maximum dimension in the surface direction of less than ⅜ inch. At least some of the recesses may be configured to receive a tip of a fastener, but all of the recesses are too small to receive a head of the fastener.

Embodiments of a method of installing a building sheet may comprise providing a building sheet having a front surface, a back surface and a thickness defined therebetween, at least one of the front and back surfaces defines a surface direction and the thickness defines a thickness direction that is substantially perpendicular to the surface direction. The method may further comprise providing recesses in said at least one of the front and back surfaces, the recesses having a maximum dimension in the surface direction of less than ⅜ inch, such that the recesses are too small to receive heads of fasteners. The method may then comprise placing the building sheet adjacent a support structure; and securing the building sheet to the support structure with fasteners in at least some of the recesses, such that the fasteners deform the building sheet at said at least some of the recesses.

Embodiments of a method of forming a texture on a building sheet may comprise forming a building sheet having a front surface, a back surface and a thickness defined therebetween, at least one of the front and back surfaces defines a surface direction and the thickness defines a thickness direction that is substantially perpendicular to the surface direction. The method also may comprise forming recesses in said at least one of the front and back surfaces, the recesses having a maximum dimension in the surface direction of less than ⅜ inch, such that the recesses are too small to receive heads of fasteners.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIGS. 1 and 2 are schematic isometric and enlarged isometric views of an embodiment of a building sheet;

FIGS. 3 and 4 are plan and enlarged plan view of another embodiment of a building sheet;

FIG. 5 is a schematic sectional side view of the embodiment of the building sheet of FIGS. 3 and 4;

FIGS. 6a and 6b are sequential schematic sectional views of an embodiment of a building sheet being installed; and

FIG. 7 is a side view of an embodiment of a roller used for forming recesses in building sheets.

The use of the same reference symbols in different drawings indicates similar or identical items.

### DETAILED DESCRIPTION

Embodiments of a system, method and apparatus for a building sheet are disclosed. For example, the building sheet may comprise a fiber cement product, such as a backer board or an underlayment. Other embodiments relate to a building sheet or backerboard for flooring or other surface treatments such as ceramic tile, countertops, walls and the like. However, it will be appreciated that the embodiments disclosed herein may be adapted and applied to other types of building sheets including but not limited to interior wallboard, wall panels, exterior sheathing, panel flooring, decking, ceiling panels, soffit panels, facade panels and general building and furniture flat panels.

Before being sized and cut to its desired dimension for installation, the building sheet is preferably a substantially flat, rectangular board. The building sheet may be formed from a fiber cement material, although other materials, such as plywood, hardboard, oriented strand board (OSB), engineered wood, fiber-matte-reinforced cement substrate sheets, cement boards, gypsum based wallboards and cement-bonded particle boards may also be used.

The fiber cement material may comprise about 20% to 60% portland cement, about 20% to 70% ground silica sand, about 0% to 12% cellulose fiber, and about 0% to 6% select additives such as mineral oxides, mineral hydroxides and water. Platelet or fibrous additives, such as, for example, wollastonite, mica, glass fiber or mineral fiber, may be added to improve the thermal stability of the fiber cement. The dry density fiber cement sheet is typically about 0.8 g/cm³ (low density) to about 1.3 g/cm³ (medium density) to about 1.8 g/cm³ or more (high density). Density can be modified by addition of density modifiers such as unexpanded or expanded vermiculite, perlite, clay, shale or low bulk density (about 0.06 to 0.7 g/cm³) calcium silicate hydrates. The moisture content of the fiber cement is preferably from about 1% to about 30%.

Typical building sheet sizes may include 3′×5′, 4′×4′, and 4′×8′ having thicknesses of preferably ¼″ or greater. Other nominal thicknesses of ⅜, 7/16, ½ and ⅝ inches also may be used.

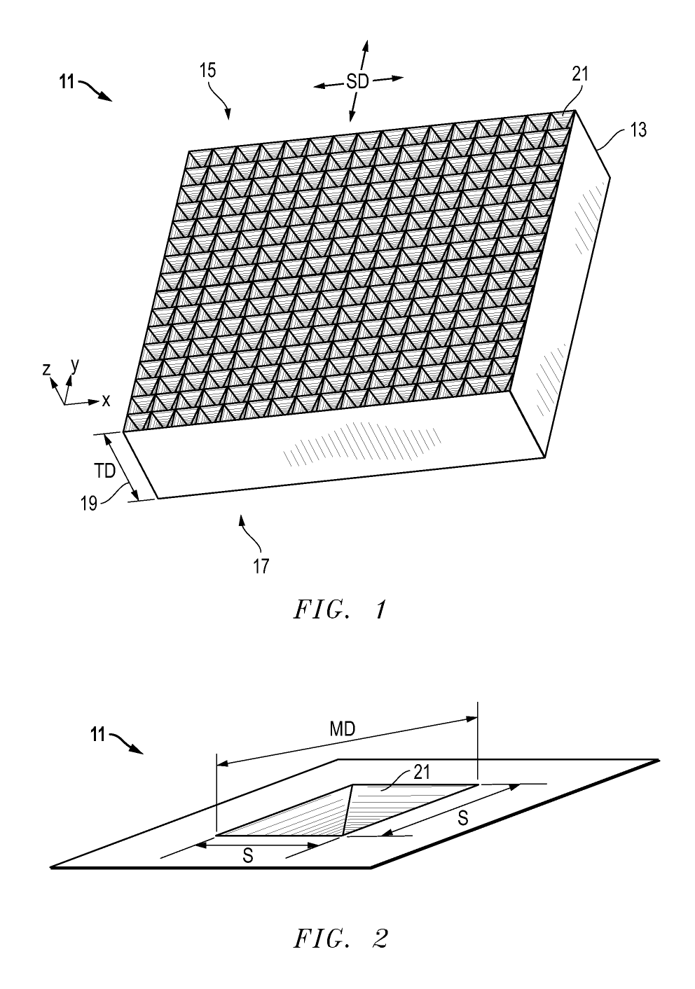

As shown in the schematic drawing of FIG. 1 (not to scale), a building sheet 11 may comprise a substantially flat board 13 having a front surface 15, a back surface 17 and a thickness 19 defined therebetween. Backer boards and underlayments typically have a thickness 19 of about ¼ inch to about ½ inch. At least one of the front and back surfaces 15, 17 may define a surface direction SD. In the embodiment of FIG. 1, front surface 15 defines the SD. The thickness 19 defines a thickness direction TD that is substantially perpendicular to the surface direction SD. Thus, as depicted by the Cartesian coordinate system in FIG. 1, the SD extends in an x-y plane, and the TD extends along the z-axis.

Building sheet 11 also has recesses 21 formed in at least one of the front and back surfaces 15, 17. The recesses 21 may be arrayed in a symmetrical pattern (e.g., a rectilinear pattern), and may have three-dimensional shapes such as the square pyramids depicted in FIG. 1. Recesses 21 also may comprise other pyramidal shapes (e.g., rectangular, triangular, etc.), semi-spherical shapes, conical shapes, or any combination thereof. The recesses 21 may have bases that are substantially flush with the at least one of the front and back surfaces 15, 17. The recesses 21 may taper in shape in the thickness direction TD from their bases to their bottoms. The recesses 21 may have non-flat bottoms. At least some of the recesses may be configured to receive a tip of a fastener therein to substantially center the tip of the fastener in the recess.

As shown in the enlarged view of FIG. 2, the recesses 21 may have a maximum dimension MD in the surface direction SD of less than ⅜ inch (i.e., 0.375 inch). At least some of the recesses 21 may be configured to receive a fastener therein. However, none of the recesses 21 are large enough to receive a head of the fastener. For example, in the square pyramid embodiment of FIGS. 1 and 2, each recess 21 has a side S having a length of about ¼ inch. Thus, the diagonal MD across recess 21 is about 0.354 inch. In contrast, typical backer screws have heads with nominal diameters of ⅜ inch, which is typically an actual size range of about 0.380 inch to about 0.385 inch). When nails are used to secure such building sheets, generally roofing nails with head diameters of about ½ inch are employed. The recesses 21 may be configured to be crushed upon installation of fasteners therein, such that heads of the fasteners are substantially flush with the board in the surface direction upon installation.

In FIG. 1, the recesses 21 are discontinuous but substantially completely cover the front surface 15 in the surface direction SD and extend adjacent to the perimeter of the board 13. Thus, there are only very small spaces between adjacent ones of the recesses.

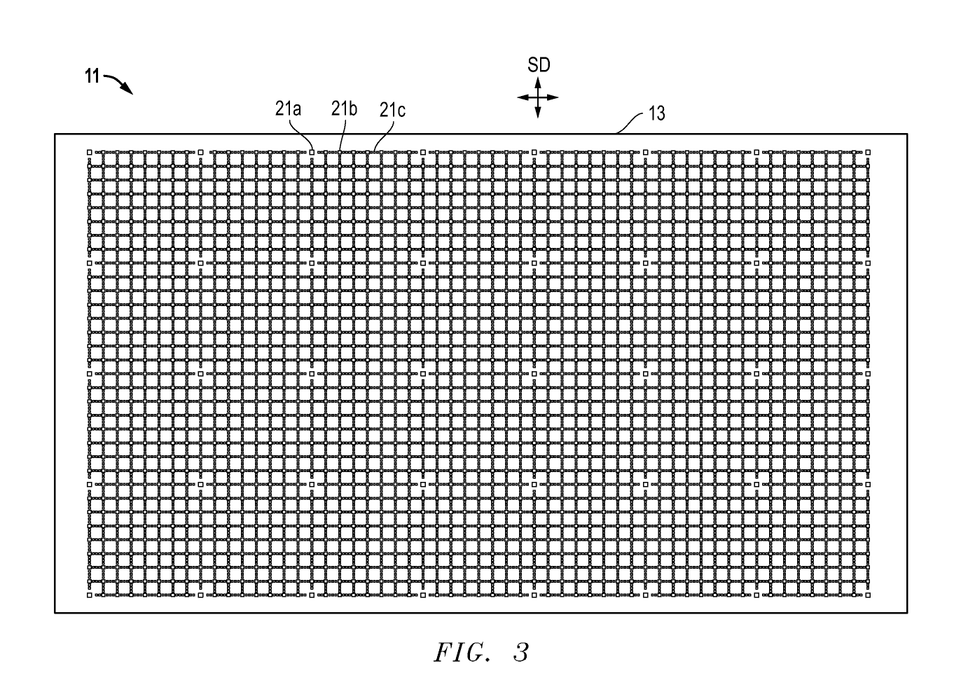

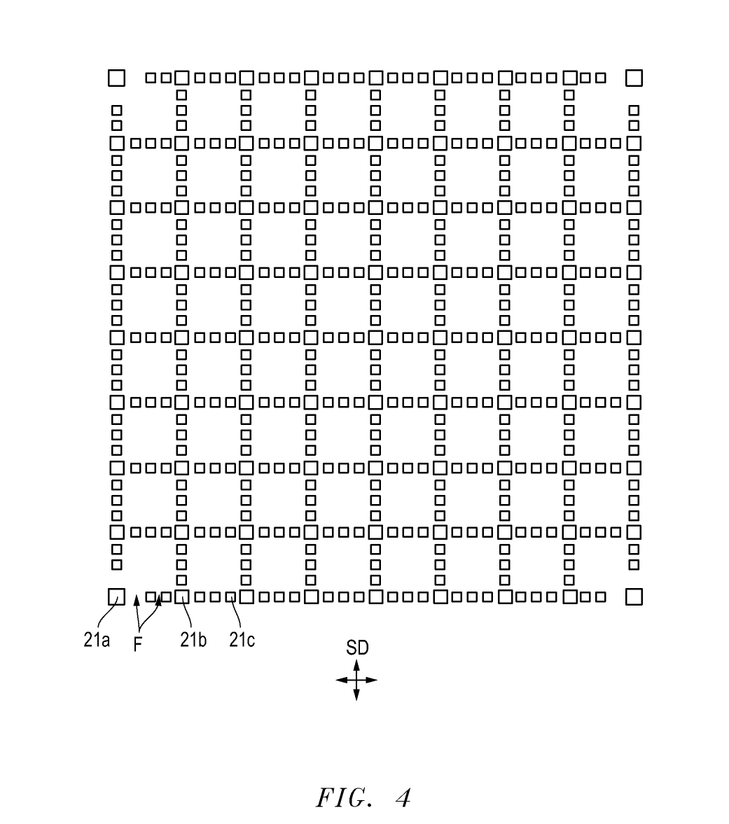

However, as shown in FIGS. 3-5, the recesses 21 also are discontinuous but may be spaced apart from each other by flats F (FIG. 4) that extend in the surface direction SD. Moreover, the recesses 21 may be spaced apart from a perimeter of the board (FIG. 3) by a distance of at least about ¼ inch to about 2 inches.

The recesses 21 may be configured in more than one size. For example, in FIGS. 3-5, the recesses comprise large recesses 21a (e.g., ¼ inch sides), medium recesses 21b (e.g., 3/16 inch sides), and small recesses 21c (e.g., ⅛ inch sides). Embodiments of these recesses may be spaced apart from each other by flats F measuring about 0.095 inch (about 0.090 inch to about 0.100 inch between recesses 21b and 21c), about 0.313 inch (about 0.300 inch to about 0.325 inch between recesses 21a and 21c), or about 0.126 inch (about 0.120 inch to about 0.130 inch between recesses 21c).

Centers of the recesses may be spaced apart from each other by about ¼ inch (between recesses 21c), or about 8 inches to about 12 inches (between recesses 21a). At least some of the recesses may comprise the medium or second type of recess 21b having a maximum dimension in the surface direction of no more than about 0.270 inches (e.g., 3/16 inch sides). The second type of recesses 21b may be arrayed in a grid pattern comprising substantially perpendicular rows and columns. Centers of adjacent ones of the second type of recesses 21b may be spaced apart from each other by about one inch.

At least some of the recesses may comprise the small or third type of recess 21c having a maximum dimension in the surface direction of no more than about 0.180 inches (e.g., ⅛ inch sides). The third type of recesses 21c may be arrayed in a grid pattern comprising substantially perpendicular rows and columns. Centers of adjacent ones of the rows and columns may be spaced apart from each other by about ¼ inch to about 2 inches (e.g., one inch in the embodiment shown). Centers of the second and third types of recesses 21b, 21c may be spaced apart from each other by at least about ¼ inch.

Centers of the recesses 21a having the maximum dimension in the surface direction of less than ⅜ inch may be spaced apart from centers of the second type of recesses 21b by at least about 1 inch, and may be spaced apart from centers of the third type of recesses 21c by at least about ½ inch. This configuration is best shown in FIG. 4, wherein each recess 21a is spaced apart from the next recess 21c by a larger flat F. Such designs facilitate the machinability of rollers used to form the recesses.

In addition, the recesses may be provided with a depth in the thickness direction TD of no more than about 0.088 inch (for recesses 21a), or no more than about 0.066 inch (for recesses 21b), or no more than about 0.044 inch (for recesses 21c). In some embodiments, only the largest of the recesses may be configured to receive fasteners, but again not the heads of the fasteners.

In some embodiments, the recesses are formed in both of the front and back surfaces, which facilitates weight reduction of the building sheet. Moreover, a pattern of the recesses formed in the front surface may differ from a pattern of the recesses in the back surface. In addition, all of the recesses may be oriented in a same direction as shown in the drawings. Alternatively, at least some of the recesses may be oriented in a different direction than other ones of the recesses. For example, some of the recesses may be oriented at a 45 degree angle relative to other ones of the recesses. Thus, when the recesses are square pyramids, the rotated recesses would appear as diamond shapes while the other recesses would appear as square shapes. Such a configuration facilitates easier recognition of fastener locations and the like.

Embodiments of a method of installing a building sheet may comprise providing a building sheet having a front surface, a back surface and a thickness defined therebetween, at least one of the front and back surfaces defines a surface direction and the thickness defines a thickness direction that is substantially perpendicular to the surface direction. The method may further comprise providing recesses in said at least one of the front and back surfaces, the recesses having a maximum dimension in the surface direction of less than ⅜ inch, such that the recesses are too small to receive heads of fasteners.

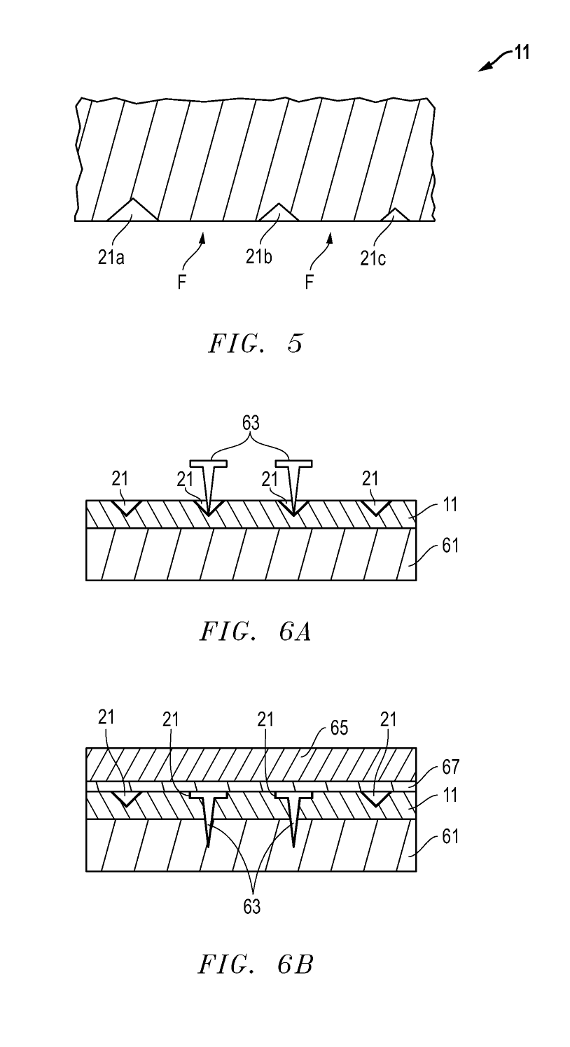

As shown in FIG. 6, the method may then comprise placing the building sheet 11 adjacent a support structure 61; and securing the building sheet to the support structure with fasteners 63 in at least some of the recesses 21 (FIG. 6a), such that the fasteners 63 deform the building sheet 11 at said at least some of the recesses 21 (FIG. 6b). Thereafter tile 65 or other products may be secured to building sheet 11, such as with adhesive 67.

Heads of the fasteners may be substantially flush with the building sheet in the surface direction after installation. The heads are not necessarily required to be flush if the adhesive thickness used to bond tile (or other materials) to the building sheet is sufficient to cover the heads.

Embodiments of a method of forming a texture on a building sheet may comprise forming a building sheet having a front surface, a back surface and a thickness defined therebetween, at least one of the front and back surfaces defines a surface direction and the thickness defines a thickness direction that is substantially perpendicular to the surface direction. The method also may comprise forming recesses in said at least one of the front and back surfaces, the recesses having a maximum dimension in the surface direction of less than ⅜ inch, such that the recesses are too small to receive heads of fasteners.

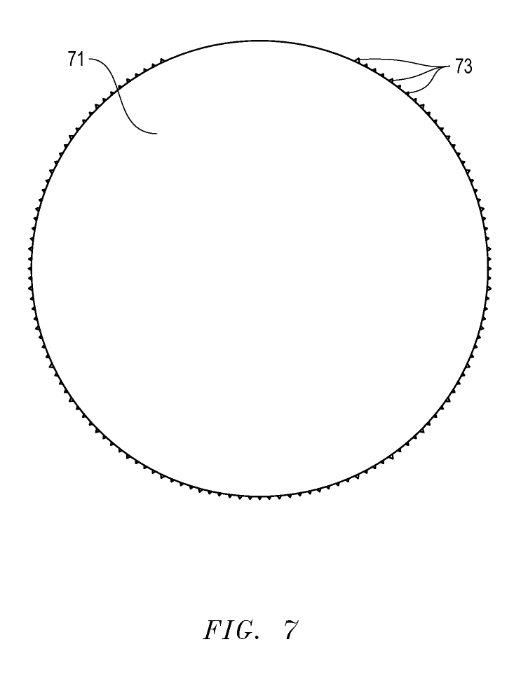

The recesses may be formed while the building sheet is still wet and uncured, and then the building sheet is dried and cured. The building sheet may be formed with sheet build-up, the recesses may be formed in the building sheet by a patterned secondary roll 71 (FIG. 7) or belt system that is downstream from sheet build-up, and the patterned secondary roll or belt may use protrusions 73 to press the recesses into said at least one of the front and back surfaces. Alternatively, the recesses may be impressed into the building sheet by a flat press system.

In another embodiment, the building sheet may comprise a plurality of layers and may be formed on an accumulator roll in a sheet build-up process. The accumulator roll may have a pattern to form the recesses while the building sheet is being built-up in layers.

In still other embodiments, the recesses may be formed after the building sheet is dry and cured. For example, the recesses may be formed by laser burning, mechanical cutting, gang drilling or heated brand burning.

The building sheet may comprise extruded fiber cement. The recesses may be formed while the building sheet is wet or after the building sheet is dry. In addition, the building sheet may be formed as a single layer rather than a plurality of layers.

Embodiments may utilize a texture comprising indentations in the top and/or bottom surfaces of fiber cement backer boards and underlayment products. The impressed pattern may comprise a series of inverted pyramids. The size and depth of the inverted pyramids may be optimized for the properties desired. For example, the inverted pyramids may be about 1/16 inch-square at the base, tapering downward at 45 degree angles, with a depth of about 1/32 inch. Such a design may provide adequate nail/screw penetration. Other dimensions such as 3/16 inch or ¼ inch inverted pyramid bases may be more appropriate for better penetration of tapered or bugle head type screws.

The inverted pyramid bases may be grouped close together, or separated by small dimensions or flats (e.g., 0.050 inches) to provide an outer plane for bearing the weight of the sheets or product above it. In addition, the outer plane would provide for standard thickness measuring of the sheets where a typical ¼″ micrometer tip face width may span across the bases of the inverted pyramids. Rows of parallel and perpendicular inverted pyramids may be aligned with the edges of the sheet or product. The shape of the indentions is not be limited to square pyramids, but may take the form of pyramids of other shapes, cones, half-spheres, or any number or combination of geometric shapes. In some embodiments, the indentions do not have a flat bottom to facilitate the starting and installation of fasteners. Thus, at least some of the recesses are configured to receive a tip of a fastener therein and substantially center the tips of the fasteners in the recesses. In other embodiments, all of the recesses may be configured to receive the tips of fasteners therein.

The surface texture formed by the recesses or indentations may not cover the entire surface of the product, as it may have a ¼ inch to 2 inch perimeter around the edge without the texture. In other embodiments text or logos such as a company name or other information may be added within the texture.

Beneficially, the indentations may be used as a reference for installers who cut or score the products. The indentations may provide a visual aid for scoring or cutting parallel to the sheet edges. The installer can measure where the product is to be cut and the rows may provide visual lines they can cut or score from for reducing the product to the desired size. Another benefit is the weight reduction of the product since the process of forming or impressing inverted pyramids displaces material at each indentation. The embodiments are also beneficial for increasing surface exposure for improved bonding of adhesives and mortars either to the substrate, or to the tiles installed over the backers or both. In addition, when nails or screw fasteners are applied through the sheet, the bases of the inverted pyramids may crush under the nailing or screwing force allowing the fastener heads to be driven substantially flush with the product surface. This design reduces issues with protruding nail or screw heads that may interfere with application of tiles to the underlayment surface.

With method embodiments, the surface texture may be formed during the sheet build up process with the pattern built unto the accumulator roll where the pattern will be transferred to the final sheet. The texture also may be formed by a secondary roll or belt system that is downstream of the sheet build-up and is pressed into the surface by a patterned roll. This roll or belt could be any number of materials including, but not limited to metals, silicone or other polymer or composite. The texture also may be impressed unto the sheet surfaces by pressure through a press system or other mechanical device capable of applying adequate pressures. In addition, the surface texture may be added by laser burning, mechanical cutting, gang drilling or heated brand burning.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A building sheet, comprising:
a substantially flat board having a front surface, a back surface and a thickness defined therebetween, at least one of the front and back surfaces defines a surface direction and the thickness defines a thickness direction that is substantially perpendicular to the surface direction; and
recesses formed in said at least one of the front and back surfaces, the recesses have a maximum dimension in the surface direction of less than ⅜ inch, such that each recess is too small to receive a head of a fastener.

2. A building sheet according to claim 1, wherein the recesses are discontinuous and spaced apart from each other by flats that extend in the surface direction.

3. A building sheet according to claim 1, wherein the recesses are configured to be crushed upon installation of fasteners therein, such that heads of the fasteners are substantially flush with the board in the surface direction upon installation.

4. A building sheet according to claim 1, wherein the building sheet is a fiber cement product.

5. A building sheet according to claim 1, wherein the building sheet is a backer board or an underlayment, and the thickness is about ¼ inch to about ½ inch.

6. A building sheet according to claim 1, wherein the recesses have three-dimensional shapes comprising pyramidal shapes, semi-spherical shapes, conical shapes, or any combination thereof.

7. A building sheet according to claim 1, wherein the recesses have bases that are substantially flush with said at least one of the front and back surfaces, and the recesses taper in shape in the thickness direction to bottoms.

8. A building sheet according to claim 1, wherein the recesses have non-flat bottoms, and at least some of the recesses are configured to receive a tip of a fastener therein to substantially center the tip of the fastener in the recess.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A method of installing a building sheet, comprising:
providing a building sheet having a front surface, a back surface and a thickness defined therebetween, at least one of the front and back surfaces defines a surface direction and the thickness defines a thickness direction that is substantially perpendicular to the surface direction;
providing recesses in said at least one of the front and back surfaces, the recesses having a maximum dimension in the surface direction of less than ⅜ inch, such that the recesses are too small to receive heads of fasteners;
placing the building sheet adjacent a support structure; and
securing the building sheet to the support structure with fasteners in at least some of the recesses, such that the fasteners deform the building sheet at said at least some of the recesses.

27. A method according to claim 26, wherein heads of the fasteners are substantially flush with the building sheet in the surface direction after installation.

28. A method according to claim 26, wherein the recesses are discontinuous and spaced apart from each other by flats that extend in the surface direction.

29. A method according to claim 26, wherein the recesses are crushed upon installation of fasteners therein, such that heads of the fasteners are substantially flush with the building sheet in the surface direction after installation.

30. A method according to claim 26, wherein the building sheet is a fiber cement product.

31. A method according to claim 26, wherein the building sheet is a backer board or an underlayment, and the thickness is about ¼ inch to about ½ inch.

32. A method according to claim 26, wherein the recesses have three-dimensional shapes comprising pyramidal shapes, semi-spherical shapes, conical shapes, or any combination thereof.

33. A method according to claim 26, wherein the recesses have bases that are substantially flush with said at least one of the front and back surfaces, and the recesses taper in shape in the thickness direction to bottoms.

34. A method according to claim 26, wherein the recesses have non-flat bottoms, and at least some of the recesses receive a tip of a fastener therein to substantially center the tip of the fastener in the recess.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. A method of forming a texture on a building sheet, comprising:
forming a building sheet having a front surface, a back surface and a thickness defined therebetween, at least one of the front and back surfaces defines a surface direction and the thickness defines a thickness direction that is substantially perpendicular to the surface direction; and
forming recesses in said at least one of the front and back surfaces, the recesses having a maximum dimension in the surface direction of less than ⅜ inch, such that the recesses are too small to receive heads of fasteners.

53. A method according to claim 52, wherein the recesses are formed while the building sheet is still wet and uncured, and then the building sheet is dried and cured.

54. A method according to claim 53, wherein the building sheet is formed with sheet build-up, the recesses are formed in the building sheet by a patterned secondary roll or belt system that is downstream from sheet build-up, and the patterned secondary roll or belt presses the recesses into said at least one of the front and back surfaces.

55. A method according to claim 53, wherein the recesses are impressed into the building sheet by a flat press system.

56. A method according to claim 53, wherein the building sheet comprises a plurality of layers and is formed on an accumulator roll in a sheet build-up process, and the accumulator roll has a pattern to form the recesses while the building sheet is being built-up in layers.

57. A method according to claim 52, wherein the recesses are formed after the building sheet is dry and cured.

58. A method according to claim 57, wherein the recesses are formed by laser burning, mechanical cutting, gang drilling or heated brand burning.

59. A method according to claim 52, wherein the building sheet is extruded fiber cement, and the recesses are formed while the building sheet is wet or after the building sheet is dry.

60. A method according to claim 52, wherein the building sheet is formed as a single layer.

61. A method according to claim 52, wherein the recesses are discontinuous and spaced apart from each other by flats that extend in the surface direction.

62. A method according to claim 52, wherein the building sheet is a fiber cement product.

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)
